(19) United States
(12) Patent Application Publication
(10) Pub. No.: US 2021/0216184 A1
(43) Pub. Date: Jul. 15, 2021

(54) ELECTRONIC DEVICE

(71) Applicant: NIKON CORPORATION, Tokyo (JP)

(72) Inventors: Sho KAMIDE, Yokohama-shi (JP); Shunichi IZUMIYA, Kawasaki-shi (JP); Hirokazu TSUCHIHASHI, Tokyo (JP); Chihiro TSUKAMOTO, Tokyo (JP); Michiyo OGAWA, Tokyo (JP); Masakazu SEKIGUCHI, Kawasaki-shi (JP)

(73) Assignee: NIKON CORPORATION, Tokyo (JP)

(21) Appl. No.: 17/215,226

(22) Filed: Mar. 29, 2021

Related U.S. Application Data
(63) Continuation of application No. 14/408,059, filed on Dec. 15, 2014.

(30) Foreign Application Priority Data
Jun. 15, 2012 (JP) 2012-135944

(51) Int. Cl. G06F 3/0488; G06F 1/16; G06F 3/0354; G06F 3/041; G06F 3/16

(52) U.S. Cl. CPC G06F 3/0488; G06F 1/1626; G06F 1/169; H04M 1/0202; G06F 3/03547; G06F 3/0412; G06F 3/167; G06F 3/04883

(57) ABSTRACT

There is provided a user-friendly electronic device including: touch sensors provided on a first surface and at least a second surface other than the first surface; a processor that displays application information based on a way of holding the electronic device by a user, the processor detecting the way of holding the electronic device using a result of detection of the touch sensors; and an assignment unit that assigns a function corresponding to an application to be run to the touch sensors.

This is a Continuation of application Ser. No. 14/408,059 filed Dec. 15, 2014, which is a National Stage Application of PCT/JP2013/062076 filed Apr. 24, 2013, which in turn claims priority to Japanese Application No. 2012-135944 filed Jun. 15, 2012. The entire disclosures of the prior applications are hereby incorporated by reference herein in their entireties.

### TECHNICAL FIELD

The present invention relates to an electronic device.

### BACKGROUND ART

Conventionally, there has been proposed a technique that performs suitable display for an operator without making the operator especially conscious of the operation of a portable device, by controlling the contents of display based on the output of a pressure sensitive sensor formed on a side surface of a cellular phone (e.g. see Patent Document 1).

### PRIOR ART DOCUMENTS

### Patent Documents

Patent Document 1: Japanese Laid-open Patent Publication No. 2008-27183

### SUMMARY OF THE INVENTION

### Problems to be Solved by the Invention

However, in the above-mentioned Patent Documents 1, only the arrangement and the sizes of character buttons are changed based on whether which of right-and-left hands holds the cellular phone.

The present invention has been made in view of the above problem, and aims to provide a user-friendly electronic device.

### Means for Solving the Problems

The electronic device of the present invention includes: touch sensors provided on a first surface and at least a second surface other than the first surface; a processor that displays application information based on a way of holding the electronic device by a user, the processor detecting the way of holding the electronic device using a result of detection of the touch sensors; and an assignment unit that assigns a function corresponding to an application to be run to the touch sensors.

In this case, the assignment unit can assign operation corresponding to a motion of a finger to a touch sensor provided on the second surface. Moreover, the assignment unit may assign a selection function of an adjustment menu about the application to be run to a touch sensor provided on the first surface, and assign a function about a degree of the adjustment of the application to be run to a touch sensor provided on the second surface.

The electronic device of the present invention may include an image-capturing unit that is provided on the first surface and is capable of capturing an image of the user, and the processor determines the way of holding the electronic device by the user based on a result of the image-capturing of the user by the image-capturing unit to display the application information on the display. Moreover, the electronic device may include an attitude detector that detects an attitude of the electronic device, and the processor may display the application information on the display based on a result of detection by the attitude detector. In this case, the attitude detector may include at least one of an acceleration sensor and an image-capturing device.

Moreover, the electronic device of the present invention may include a position detector that detects a position of the electronic device, and the processor may display the application information on the display based on a result of detection by the position detector. Moreover, the processor may determine a motion of the finger of the user, and display the application information corresponding to the result of the determination on the display.

Moreover, the processor may determine an attribute of the user from the result of detection of the touch sensors, and display the application information corresponding to the result of the determination on the display. Moreover, the processor may give priority to information that relates to a plurality of applications to display the information on the display based on the priority.

The electronic device of the present invention may have a rectangular parallelepiped shape having six surfaces which includes the first surface, and the touch sensors may be provided on the six surfaces of the rectangular parallelepiped shape, respectively. Moreover, the electronic device may include a pressure-sensitive sensor that detects a holding power by the user, and the assignment unit may assign the function corresponding to the application to be run to the pressure-sensitive sensor. Moreover, the display may be a transmission type display.

The electronic device of the present invention may include a vibrator that generates vibration in the first surface and the second surface, respectively. Moreover, the electronic device of the present invention may include a controller that vibrates the vibrator according to at least one of processing by the processor and assignment by the assignment unit.

### Effects of the Invention

The present invention can provide a user-friendly electronic device.

### BRIEF DESCRIPTION OF DRAWINGS

FIG. 1 is a diagram illustrating six surfaces of a portable device according to an embodiment;

FIG. 2 is a block diagram illustrating the configuration of the portable device;

FIG. 3 is a flowchart illustrating a process of a control unit;

FIG. 4 is a flowchart illustrating a concrete process of step S14 in FIG. 3;

FIGS. 5A to 5C are diagrams explaining a pattern 1 of a way of holding the portable device;

FIGS. 6A and 6B are diagrams explaining a pattern 2 of a way of holding the portable device;

FIGS. 7A to 7D are diagrams explaining patterns 3 and 4 of a way of holding the portable device;

FIGS. 8A to 8C are diagrams explaining a pattern 5 of a way of holding the portable device; and

FIG. 9 is a diagram illustrating an example of assignment of a function to a touch sensor.

### MODES FOR CARRYING OUT THE INVENTION

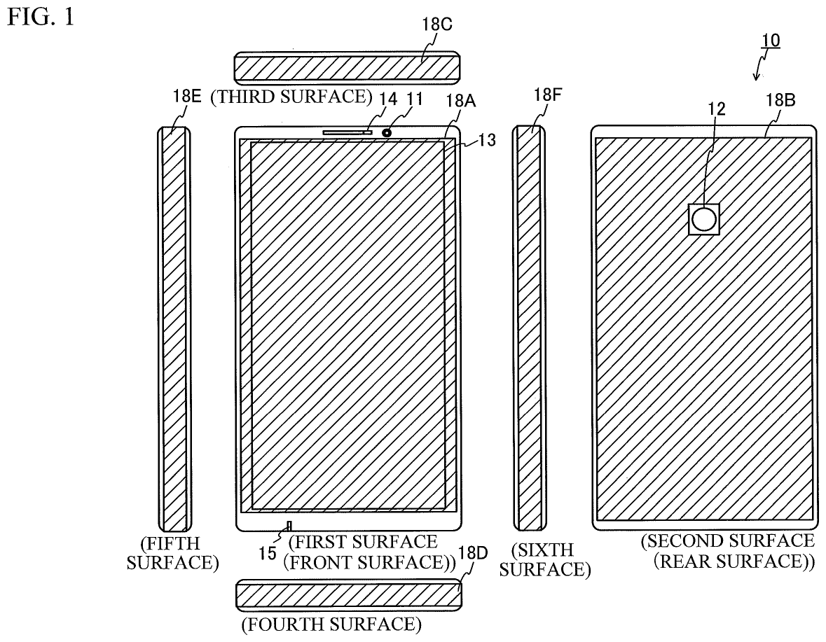

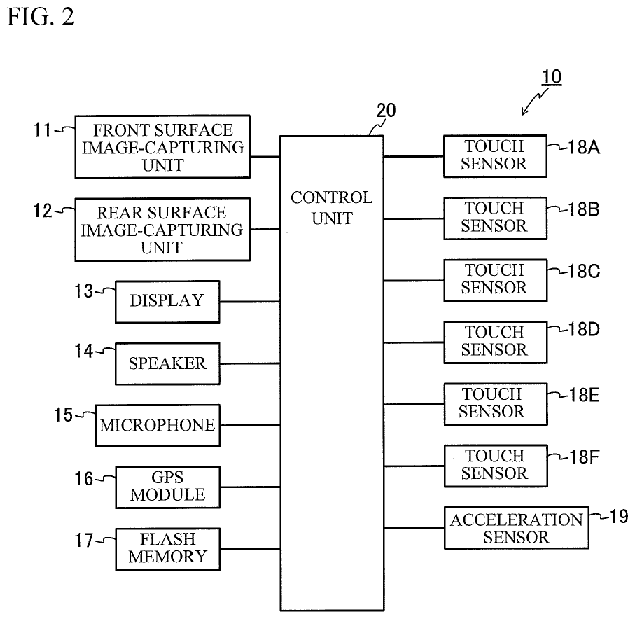

Hereinafter, a detailed description will be given of a portable device according to an embodiment, based on FIGS. 1 to 9. FIG. 1 is a diagram illustrating six surfaces of the portable device according to the embodiment. FIG. 2 is a block diagram illustrating the configuration of the portable device 10.

The portable device 10 is a device such as a cellular phone, a smart phone, a PHS (Personal Handy-phone System) and a PDA (Personal Digital Assistant). The portable device 10 has a telephone function, a communication function for connecting to an internet or the like, a data processing function for executing programs, and so on. As an example, the portable device 10 has a sheet-like form including a rectangular first surface (a front surface), a rectangular second surface (a rear surface) and rectangular third to sixth surfaces (side surfaces), as illustrated in FIG. 1, and has a size which can be held in the palm of one hand.

The portable device 10 includes a front surface image-capturing unit 11, a rear surface image-capturing unit 12, a display 13, a speaker 14, a microphone 15, a GPS (Global Positioning System) module 16, a flash memory 17, touch sensors 18A to 18F, an acceleration sensor 19 and a control unit 20, as illustrated in FIG. 2.

The front surface image-capturing unit 11 is provided in the vicinity of an upper end of the first surface (a front surface), and includes a photographing lens, a CCD (Charge Coupled Device) and a CMOS (Complementary Metal Oxide Semiconductor) device. The front surface image-capturing unit 11 captures an image of a surface of a user holding the portable device 10 as an example.

The rear surface image-capturing unit 12 is provided in a little upper part from the center of the second surface (the rear surface), and has a photographing lens and an imaging element as with the front surface image-capturing unit 11. The rear surface image-capturing unit 12 captures an image of feet of the user holding the portable device 10 as an example.

The display 13 is a device using liquid-crystal-display elements, for example, and displays images, various information, and images for operation input, such as buttons. The display 13 has a rectangular form, as illustrated in FIG. 1, and has an area which occupies almost the whole surface of the first surface.

The speaker 14 is provided on an upper side of the display 13 on the first surface, and is located near a user's ear when the user makes a call. The microphone 15 is provided on a lower side of the display 13 on the first surface, and is located near a user's mouth when the user makes a call. That is, the speaker 14 and the microphone 15 sandwich the display 13 and are provided near the short sides of the portable device 10, as illustrated in FIG. 1.

The GPS module 16 is a sensor that detects a position (e.g. a latitude and a longitude) of the portable device 10. The flash memory 17 is a nonvolatile semiconductor memory. The flash memory 17 stores programs which the control unit 20 executes, parameters to be used in processing which the control unit 20 executes, data about parts of a face such as eyes, a nose, and a mouth, in addition to data such as a telephone number and a mail address, and so on.

The touch sensor 18A is provided so as to cover the surface of the display 13 in the first surface, and inputs information indicating that the user touched the touch sensor 18A, and information according to a motion of a user's finger. The touch sensor 18B is provided so as to cover almost the whole surface of the second surface, and inputs information indicating that the user touched the touch sensor 18B, and information according to a motion of a user's finger. The other touch sensors 18C to 18F are provided so as to cover almost the surface of the third to sixth surfaces, and inputs information indicating that the user touched the touch sensors, and information according to a motion of a user's finger, as with the touch sensors 18A and 18B. That is, in the present embodiment, the touch sensors 18A to 18F are provided on the six surfaces of the portable device 10, respectively. Here, the touch sensors 18A to 18F are electrostatic capacitance type touch sensors, and can judge that the user's finger contacted two or more places.

A piezoelectric element, a strain gauge and the like can be used for the acceleration sensor 19. In the present embodiment, the acceleration sensor 19 detects whether the user is standing, sitting down, walking or running. A method for detecting whether the user is standing, sitting down, walking or running by using the acceleration sensor is disclosed in Japanese Patent No. 3513632 (or Japanese Laid-open Patent Publication No. 8-131425). A gyro sensor that detects an angular velocity may be used instead of the acceleration sensor 19 or in conjunction with the acceleration sensor 19.

An attitude sensor 23 which judges whether the portable device 10 is held in a horizontal position or a vertical position may be provided. The attitude sensor may use the position of the finger which each of the touch sensors 18A to 18F detects, and use an image-capturing result of the front surface image-capturing unit 11 (an image-capturing result of the user's face). Moreover, a triaxial acceleration sensor or a gyro sensor may be adopted as an exclusive attitude sensor, for example, and may be used in combination with each of the above-mentioned touch sensors 18A to 18F, the front surface image-capturing unit 11 and the like. When the acceleration sensor is used as the attitude sensor, the acceleration sensor may detect inclination of the portable device 10. The acceleration sensor 19 may be used for two purposes.

The control unit 20 includes a CPU, and controls the portable device 10 totally. In the present embodiment, when the user performs a given application with the portable device 10, the control unit 20 judges a way of holding the portable device 10, and performs processing that displays an icon (i.e., information) of the application according to the holding way. Here, the portable device 10 can include an application having a speech recognition function, as an example of an application.

Here, in the present embodiment, since the touch sensors are provided on all six surfaces of the portable device 10, it is desirable to perform communication with an external device and charge by wireless communications (a transfer jet and a radio WiFi), non-point-of-contact charge, and so on.

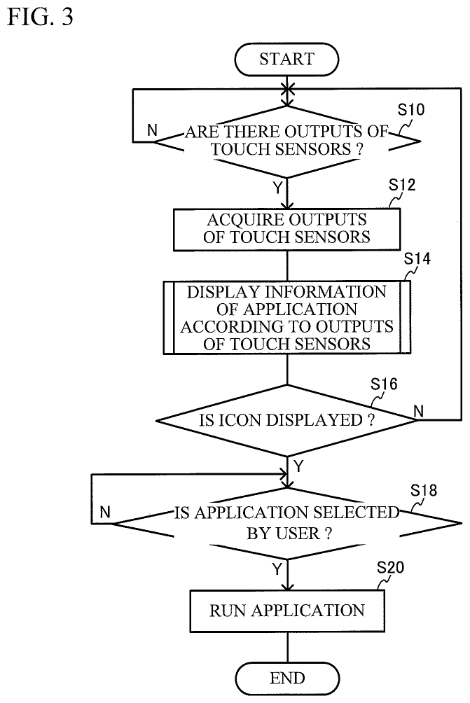

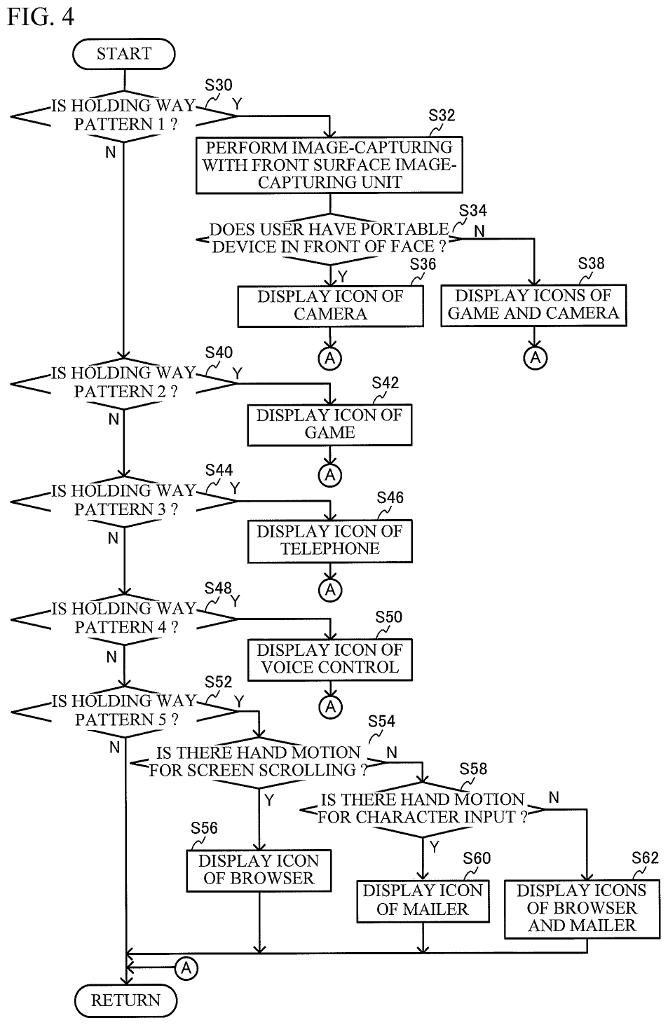

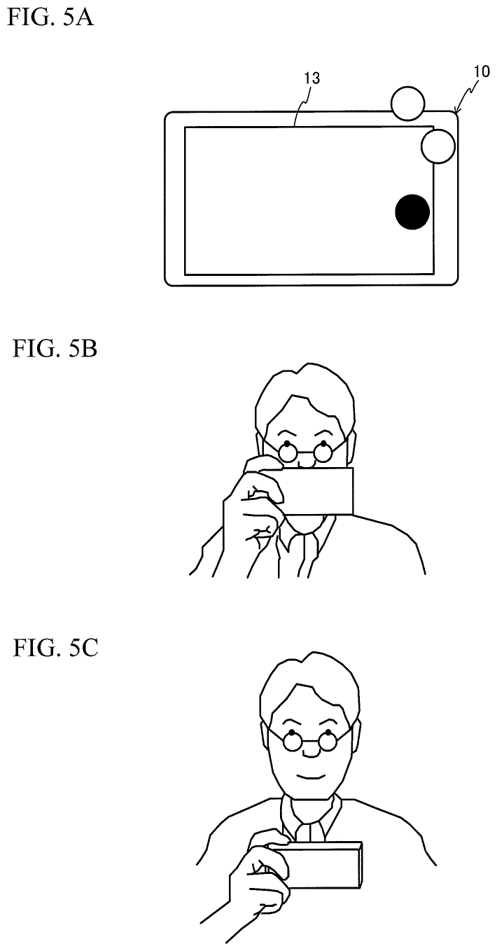

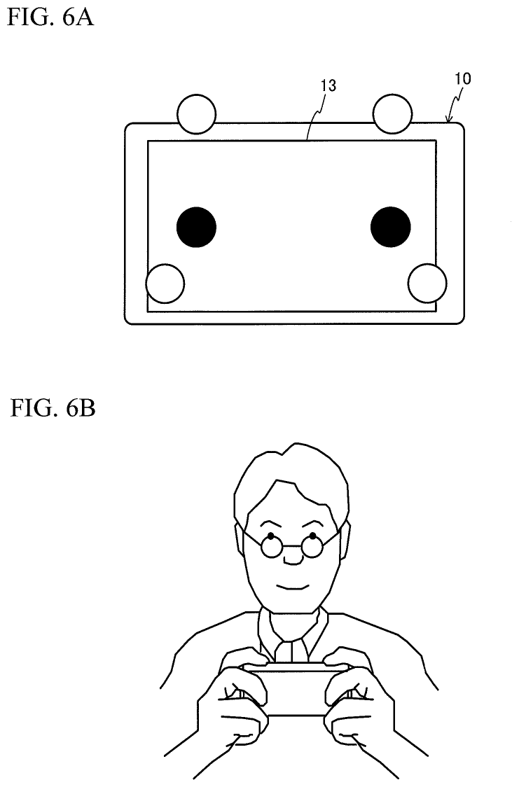

Next, a detailed description will be given of processing of the control unit 20, according to flowcharts of FIGS. 3 and 4. Here, the processing of FIG. 3 is processing to be performed in a standby state of the portable device 10 (a state where the application is not run). When the user wants to run a given application in the portable device 10, it is defined (described) in a manual of the portable device 10 that the user needs to reproduce the way of holding the portable device 10 at the time of using the application, as a premise. Therefore, when the user wants to use an application of a camera, for example, the user adopts a way of holding the portable device as illustrated in FIG. 5B. When the user wants to use an application of a game, for example, the user adopts a way of holding the portable device as illustrated in FIG. 6B.

In the processing of FIG. 3, the control unit 20 waits in step S10 until there are outputs of the touch sensors 18A to 18F. That is, the control unit 20 waits until the portable device 10 is held by the user.

When the portable device 10 is held by the user, the control unit 20 advances to step S12, and acquires the outputs of the touch sensors. The control unit 20 always may acquire the outputs of the touch sensors 18A to 18F when there are outputs of the touch sensors 18A to 18F. However, for example, the control unit 20 may acquire only the outputs of the touch sensors 18A to 18F several seconds after the user performs a certain action (e.g. the user taps the display n times or shakes the portable device 10 strongly).

Next, in step S14, the control unit 20 performs processing that displays information of the application according to the outputs of the touch sensors 18A to 18F. Specifically, the control unit 20 performs processing according to the flowchart of FIG. 4.

In FIG. 4, first, the control unit 20 judges in step S30 whether the way of holding the portable device is a pattern 1. Here, the pattern 1 is a pattern of the way of holding the portable device as illustrated in FIG. 5A, for example. A mark “black circle” in FIG. 5A means the output by the touch sensor 18B on the second surface (i.e., the rear surface), and marks “white circles” mean the outputs by the touch sensors on the other surfaces. In the pattern 1 of the way of holding the portable device illustrated in FIG. 5A, there is a high possibility that the user holds the portable device 10 in the horizontal position (a position where the user holds the portable device 10 in a horizontal long state) as illustrated in FIGS. 5B and 5C. When the judgment of step S30 is positive, the control unit 20 advances to step S32.

In step S32, the control unit 20 performs image-capturing with the use of the front surface image-capturing unit 11. Next, in step S34, the control unit 20 judges whether the user has the portable device 10 in front of the face, based on an image-capturing result. In this case, the control unit 20 judges whether the user has the portable device 10 in front of the face or below the face, based on a position of the face, positions of eyes, the form of a nose and so on in a captured image. Instead of or in addition to this, the above-mentioned attitude sensor detects the inclination of the portable device 10, so that the control unit 20 may judge a position where the user holds the portable device 10. Specifically, when the user holds the portable device 10 in front of the face as illustrated in FIG. 5B, the portable device 10 is held in a near-vertical state. On the other hand, when the user holds the portable device 10 below the face as illustrated in FIG. 5C, the portable device 10 is held in an inclined state, compared to a state illustrated in FIG. 5B. Thus, the control unit 20 may judge a position where the user holds the portable device 10 from a condition of the inclination of the portable device 10.

When the judgment in step S34 is positive, i.e., the user holds the portable device 10 as illustrated in FIG. 5B, the control unit 20 advances to step S36, and displays an icon of the application of the camera on the display 13. The reason why the control unit 20 does not display the icon of the application of the game in step S36 is that there is a low possibility that the user will perform the game in an attitude as illustrated in FIG. 5B. After step S36, the control unit 20 advances to step S16 of FIG. 3. On the other hand, when the judgment of step S34 is negative, i.e., the user holds the portable device 10 as illustrated in FIG. 5C, the control unit 20 displays the icons of the applications of the game and the camera on the display 13. In this case, since the user holds the portable device 10 in one hand, it is considered that a possibility of trying to use the application of the camera (i.e., the user is going to photograph a lower part with the camera) is higher than a possibility of trying to use the application of the game. Therefore, the control unit 20 may make the priority of the icon of the application of the camera higher than the priority of the icon of the application of the game, and display the icons. In this case, the control unit 20 may display the icon of the application of the camera so as to become larger than the icon of the application of the game, for example, or may display the icon of the application of the camera above the icon of the application of the game. After the processing of step S38 is performed, the control unit 20 advances to step S16 of FIG. 3. Also when the user holds the portable device 10 by both hands in the attitude illustrated in FIG. 5B, the display of the application of the camera is made conspicuous.

On the other hand, when the judgment of step S30 of FIG. 4 is negative, the control unit 20 advances to step S40. In step S40, the control unit 20 judges whether the way of holding the portable device 10 by the user is a pattern 2. Here, the pattern 2 is a pattern of the way of holding the portable device as illustrated in FIG. 6A, for example. In the pattern 2 of the way of holding the portable device illustrated in FIG. 6A, there is a high possibility that the user holds the portable device 10 in the horizontal position as illustrated in FIG. 6B. Therefore, when the judgment of step S40 is positive, the control unit 20 advances to step S42, displays the icon of the application of the game, and then advances to step S16 of FIG. 3.

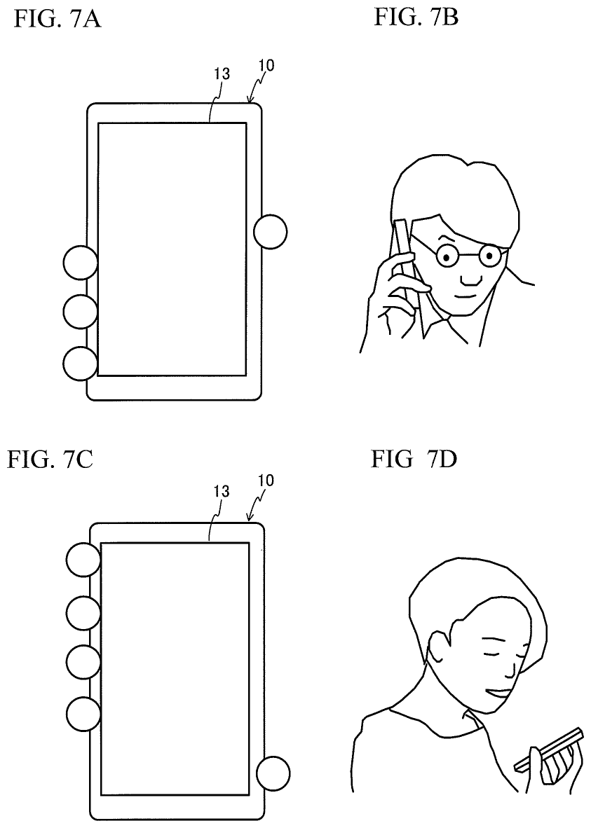

On the contrary, when the judgment of step S40 is negative, the control unit 20 judges in step S44 whether the way of holding the portable device 10 by the user is a pattern 3. Here, the pattern 3 is a pattern of the way of holding the portable device as illustrated in FIG. 7A, for example. In the pattern 3 of the way of holding the portable device illustrated in FIG. 7A, there is a high possibility that the user holds the portable device 10 in a vertical position (a position where the user holds the portable device 10 in a vertical long state) as illustrated in FIG. 7B. Therefore, when the judgment of step S44 is positive, the control unit 20 advances to step S46, displays an icon of an application of a telephone, and advances to step S16 of FIG. 3. Here, various applications may exist in the application of the telephone. For example, there are applications (skype, viber, etc.) of the telephone using the internet besides the telephone function which the portable device 10 has. In such a case, all the applications may be displayed, or one or more icons of the application often used may be displayed. Instead of step S46, when the touch sensor 18A detects that the user's ear touches the first surface as illustrated in FIG. 7B, an application of the voice control which is an application operating the portable device 10 in voice may be run. In this case, when the user calls a name (for example, Taro Suzuki) of a person to whom the user wants to make a call, the control unit 20 may automatically make a call using a telephone number stored into the flash memory 17. Here, when the judgment of step S44 is negative, the control unit 20 advances to step S48. Moreover, when the user uses the telephone function, there are a case where the user holds the portable device 10 in a right hand and a case where the user holds the portable device 10 in a left hand. Therefore, also when the way of holding the portable device of FIG. 7A is reversed, the application of the telephone may be displayed.

In step S48, the control unit 20 judges whether the way of holding the portable device 10 by the user is a pattern 4. Here, the pattern 4 is a pattern of the way of holding the portable device 10 in the vertical position and in a position where the portable device 10 is opposite to a position of the user's mouth, as illustrated in FIG. 7C, for example. That is, this is a way of holding the portable device 10 in which the front surface image-capturing unit 11 can capture an image of the user's mouth. In the pattern 4 of the way of holding the portable device illustrated in FIG. 7A, there is a high possibility that the user holds the portable device 10 as illustrated in FIG. 7D. Therefore, when the judgment of step S48 is positive, the control unit 20 advances to step S50, displays an icon of the application of the voice control, and then advances to step S16 of FIG. 3. On the contrary, when the judgment of step S48 is negative, the control unit 20 advances to step S52.

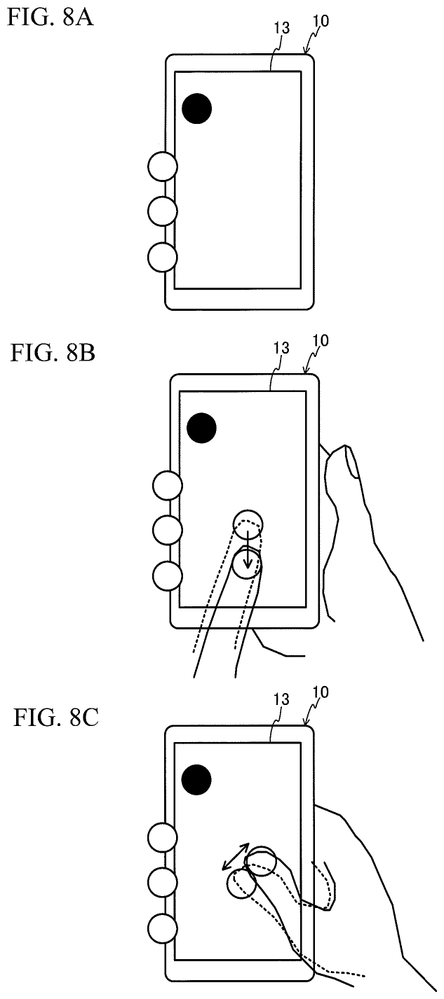

In step S52, the control unit 20 judges whether the way of holding the portable device 10 by the user is a pattern 5. Here, the pattern 4 is a pattern of the way of holding the portable device 10, as illustrated in FIG. 8A, for example. In the pattern 5 of the way of holding the portable device illustrated in FIG. 8A, there is a high possibility that the user holds the portable device 10 in the vertical position as illustrated in FIGS. 8B and 8C. When the judgment of step S52 is positive, the control unit 20 advances to step S54.

Here, it is defined (described) in the manual of the portable device 10 that the user needs to perform a pseudo operation which scrolls the display 13 (i.e., the touch sensor 18A) with a finger as illustrated in FIG. 8B when the user wants to use a browser, and the user needs to perform a pseudo operation of character input to be actually performed with a mailer as illustrated in FIG. 8C when the user wants to use the mailer (i.e., software that performs creation, transmission, reception, save, and management of an E-mail).

In step S54, the control unit 20 judges whether there is a hand motion for screen scrolling. When the judgment of step S54 is positive, the control unit 20 displays an icon of the browser on the display 13 in step S56. On the other hand, when the judgment of step S54 is negative, the control unit 20 advances to step S58.

In step S58, the control unit 20 judges whether there is a hand motion for character input. When the judgment of step S58 is positive, the control unit 20 displays an icon of the mailer on the display 13 in step S60. On the other hand, when the judgment of step S58 is negative, i.e., there is no hand motion of FIGS. 8B and 8C, the control unit 20 advances to step S62.

Advancing to step S62, the control unit 20 displays the icons of the browser and the mailer on the display 13. When the control unit 20 cannot judge the priority of the browser and the mailer, the control unit 20 needs to display the icons of the browser and the mailer side by side. On the contrary, when the user usually uses the mailer frequently among the browser and the mailer, the control unit 20 needs to set the priority of the mailer than that of the browser and display the icon of the mailer.

After each processing of steps S56, S60 and S62 is completed, the control unit 20 advances to step S16 of FIG. 3. Here, also when the judgment of step S52 is negative, i.e., the way of holding the portable device by the user does not correspond to all of the patterns 1 to 5 (i.e., when any icon is not displayed on the display 13), the control unit 20 advances to step S16 of FIG. 3.

Returning to FIG. 3, in step S16, the control unit 20 judges whether the icon is displayed on the display 13. When the judgment of step S16 is negative, the control unit 20 returns to step S10. On the other hand, when the judgment of step S16 is positive, the control unit 20 advances to step S18.

Advancing to step S18, the control unit 20 waits until the application is selected by the user (i.e., until the icon of the application to be run is tapped). Then, when the application is selected by the user, the control unit 20 runs the selected application in step S20, and all the processing of FIG. 3 is completed.

Here, when the control unit 20 runs the application, the control unit 20 assigns a function to each of the touch sensors 18A to 18F according to the run application. Hereinafter, the assignment is explained concretely.

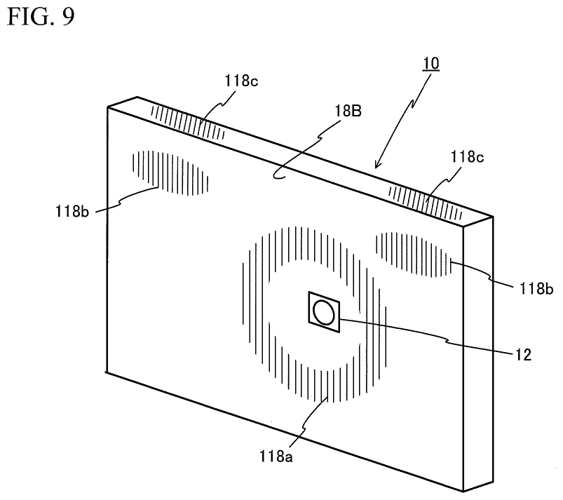

When the control unit 20 runs the application of the camera, for example, the control unit 20 assigns a circular domain 118a around the rear surface image-capturing unit 12 among the touch sensor 18B to a zoom operation, as illustrated in FIG. 9. Moreover, the control unit 20 assigns domains 118b near corner portions of the touch sensor 18B to an operation for adjustment. An operation for determining objects (aperture diaphragm, exposure, and so on) to be adjusted is assigned to the touch sensor 18A on a side of the display 13. Moreover, the control unit 20 assigns domains 118c near both ends of the touch sensor 18E in a longitudinal direction to a release operation.

Piezoelectric elements are provided on touch sensor surfaces (in the above-mentioned example, the first, the second and the fifth surfaces) which have assignment of the functions among the respective touch sensors 18A to 18F, and the surfaces to which the functions are assigned are vibrated. Thereby, a tactile sense can report the assignment of the functions to the user. When the functions are assigned to the surfaces, the report by the vibration of the piezoelectric elements may be performed in order by setting a time lag. When a plurality of releases 118c are assigned as illustrated in FIG. 9, the piezoelectric elements may be provided on a right-hand side and a left-hand side of the fifth surface (i.e., the touch sensor 18E), may be vibrated at a same phase, and may report to the user that a plurality of release functions are assigned. When a user's finger is on the left-hand side of the touch sensor 18E of the fifth surface, only the piezoelectric device of the left-hand side may be made to drive, and may report to the user that the release is possible with the left finger. The piezoelectric element of the second surface or the first surface may be made to drive in response to the touch of the user of the adjustment domains 118b provided on the second surface and a decision domain provided on the first surface, and may report having received an operation to the user by a tactile sense.

Moreover, when display of the display 13 is changed according to the way of holding the portable device 10 (like the flowchart of FIG. 4), the piezoelectric element provided on the first surface or the surface on which the user's finger is located may be vibrated, and the change of display of the display 13 may be reported to a user, and the piezoelectric element may be vibrated according to a next user's operation. Here, vibratory control of the piezoelectric element which generates vibration is also performed by the control unit 20.

Thus, the user performs the same operation as the operation (e.g. the operation which rotates a zoom ring in the circular domain 118a) usually performed with a single-lens reflex camera, a compact digital camera, and so on, and hence the user can intuitively operate the application of the camera run in the portable device 10. Moreover, by assigning the function approximately symmetrically to each of the touch sensors 18A to 18F as mentioned above, each function can be assigned to a position where the user easily operates regardless of whether the user is right-handed or left-handed. Since various operations are assigned to different surfaces of the portable devices 10, the user's fingers do not cross (interference) mutually and smooth operation can be realized.

Moreover, when the control unit 20 runs the application of the game, for example, the control unit 20 assigns functions of required operation to the respective touch sensors 18A to 18F. When the control unit 20 runs the other application such as the browser and the mailer, the control unit 20 assigns the function of the screen scrolling to the touch sensors 18E and 18F.

Moreover, in the application which needs the character input, the control unit 20 assigns a function which can perform the character input according to a number of fingers moved and which fingers was moved, to the touch sensor, for example.

The order of the respective judgments (S30, S40, S44, S48 and S52) of FIG. 6 is one example. Therefore, the order may be changed properly if needed. Moreover, a part of the respective processing and the respective judgments of FIG. 6 may be omitted.

As described above in detail, according to the present embodiment, the touch sensors 18A to 18F are provided on the surfaces of the portable device 10, and the control unit 20 judges the way of holding the portable device 10 by the user based on the detection results of the touch sensors 18A to 18F, displays on the display 13 the icon of the application according to the judgment result, and assigns the function according to the application to be run, to the touch sensors 18A to 18F. Therefore, in the present embodiment, when the user holds the portable device 10 to use a given application, the icon of the given application is displayed on the display 13. The user does not need to perform the operation, as is conventionally done, of finding and selecting the icon of the application to be used from now among many icons. Thereby, the usability of the portable device 10 can be improved. Even if the user is upset with an emergency state or a hand is unsteady in a drunkenness state, an application which the user wants to use can be run easily. Therefore, the usability of the portable device 10 can be improved also from this point. Moreover, in the present embodiment, since the function is assigned to the touch sensors 18A to 18F according to an application, the operability in the application can be improved.

Moreover, in the present embodiment, the control unit 20 judges a differences of the way of holding the portable device 10 by the user (e.g. a difference of the holding way, such as FIGS. 5B and 5C) based on the image-capturing result of the user by the front surface image capturing unit 11, and displays the icon of the application on the display 13 according to the judgment result. Therefore, the icon of the application that is more likely to be used from now on can be properly displayed based on whether the user hold the portable device 10 in front of the face or in front of a breast.

Moreover, in the present embodiment, the control unit 20 displays the icon of the application on the display 13 based on a motion of the user's finger on the touch sensor 18A (see FIG. 8). Therefore, even when the ways of holding the portable device 10 are almost the same like the browser and the mailer, the icon of the application which the user is going to use can be properly displayed on the display 13 from the motion of the finger.

Moreover, in the present embodiment, the control unit 20 gives priorities to the icons of the plurality of applications, and displays the icons of the applications on the display 13. Thereby, even when the icons of the applications are displayed on the display 13 according to the way of holding the portable device 10, it becomes easy for a user to choose application with a high possibility of using since the priorities are given to the icons and the icons are displayed.

Moreover, in the present embodiment, when the operation according to the motion of the finger is assigned to the touch sensor 18B opposite to the display 13, the user can operate the portable device 10 by moving the finger (for example, an index finger) while looking at the display 13. Thereby, the operability of the portable device 10 is improved, and various operations using a thumb and the index finger are attained.

The control unit 20 can assign a selection function of an adjustment menu about the application to be run (e.g. a function that selects the aperture diaphragm and the exposure in the case of a digital camera) to the touch sensor 18A, and assign a function about a degree of the adjustment of the application to be run (e.g. a function that increases the aperture diaphragm, or the like) to the touch sensor 18B. Therefore, the portable device 10 can be operated by the same operation (i.e., a pseudo operation on the touch panel) as a normal device (e.g. a single-lens reflex camera).

In the above-mentioned embodiment, the description is given of a case where the control unit 20 displays the icon of the application based on the way of holding the portable device 10, but the display method is not limited to this. For example, the control unit 20 may display the icon of the application that the user is more likely to use, further in consideration of a position and posture of the user. For example, it is assumed that it can be judged that, in the case where there is a high possibility of using either a camera or a game, the user exists in a train from the position detection result by the GPS module 16 and the user is sitting down from the detection result of the acceleration sensor 19. In this case, since the user is calm in the train, the control unit 20 judges that there is a high possibility that the user uses the game, and the control unit 20 displays the icon of the application of the game with a priority higher than the icon of the application of the camera on the display 13. When the user walks a road, the control unit 20 displays an icon of an application for navigation. When the user exists in a station yard, the control unit 20 displays an icon of an application for transfer guidance. Here, the control unit 20 may judge whether the user is sitting down or standing with the use of not only the detection result of the acceleration sensor 19 but also the image-capturing result of the rear surface image-capturing unit 12, for example. When a knee is image-captured by the rear surface image-capturing unit 12, the control unit 20 may judge that the user is sitting down, for example. When a shoe is image-captured, the control unit 20 may judge that the user is standing, for example.

Here, a position of the portable device 10 (i.e., the user) may be detected by using connection destination information (i.e., base station information) of radio-WiFi.

Here, in the above-mentioned embodiment, the description is given of a case where the touch sensors are provided on all the six surfaces of the portable device 10, but the installation place of the touch sensors is not limited to this. For example, one touch sensor may be provided on the first surface (i.e., the front surface) and the other touch sensor may be provided on at least one of the other surfaces.

Moreover, in the above-mentioned embodiment, a transmission type double-sided display may be adopted as the display 13. In this case, the user can look at a menu on the first surface (i.e., the front surface) and further look at the opposite side (i.e., the rear surface). Therefore, the user can operate the touch sensor 18B while looking at the position of the finger on the second surface (i.e., the rear surface).

Here, in the above-mentioned embodiment, the control unit 20 may detect a user's attribute from a fingerprint by using the touch sensors 18A to 18F, and display the icon of the application according to the attribute. By doing so, the icon according to the user's attribute can be displayed. For example, the control unit 20 can display an application which the user uses well (i.e., preferential display), and can be prevented from displaying an application which the user must not use (e.g. a parental lock function). Here, the detection of the fingerprint using the touch sensor is disclosed in Japanese Laid-open Patent Publication No. 2010-55156, for example. Moreover, when the control unit 20 can recognize that the user is sitting on a driver's seat of a car from the image-capturing result of the rear surface image-capturing unit 12 (i.e., when a handle is image-captured from a front face), the control unit 20 may control starting of an application which has disadvantage in the driving.

Moreover, in the above-mentioned embodiment, the control unit 20 may detect that the user has shaken the portable device 10, by using the acceleration sensor 19, and may judge the way of holding the portable device 10 when the portable device 10 has been shaken, by using the touch sensors 18A to 18F. By doing so, when the user does not need the icon, the occurrence of a malfunction that the icon is displayed can be controlled.

Moreover, in the above-mentioned embodiment, a pressure-sensitive sensor may be provided on each surface along with the touch sensor. In this case, the control unit 20 may recognize the case where the user holds the portable device 10 strongly and the case where the user holds the portable device 10 weakly, as different operations. When the user holds the portable device 10 strongly in a state where the application of the camera runs, the control unit 20 may capture an image in high image quality, for example. When the user holds the portable device 10 weakly in a state where the application of the camera runs, the control unit 20 may capture an image in low image quality, for example.

A housing of the portable device 10 may be manufactured by a material in which a shape thereof can change flexibly. In this case, the control unit 20 may display the icon of the application and receive the operation, according to the change (e.g. twist) of the shape by the operation of the user.

The above-mentioned embodiment is a preferable embodiment of the present invention. However, the present invention is not limited to the above-mentioned embodiment, and other embodiments, variations and modifications may be made without departing from the scope of the present invention. The entire disclosure of the publication cited in the above description is incorporated herein by reference.

1-20. (canceled)

21. An electronic device comprising:
a display unit;
a detection unit that detects a touch to the electronic device; and
a control unit that, when the detection unit detects that a finger touches a back side of the electronic device, causes information on a first application assigned to a particular way of touching the back side by the finger to be displayed on the display unit, the back side being an opposite side from the display unit of the electronic device.

22. The electronic device according to claim 21, wherein when the detection unit detects that the finger touches the display unit, the control unit causes information on a second application assigned to a particular way of touching the display unit by the finger to be displayed on the display unit.

23. The electronic device according to claim 21, wherein when the detection unit detects that the finger touches the display unit, the control unit identifies a movement of the finger on the display unit and causes information on a third application assigned to the identified movement of the finger to be displayed on the display unit.

24. An electronic device comprising:
a display unit;
a detection unit that detects a touch to the electronic device; and
a control unit that, when the detection unit detects that a finger touches a back side of the electronic device, causes the electronic device to execute an operation assigned to a particular way of touching the back side by the finger, the back side being an opposite side from the display unit of the electronic device.

25. The electronic device according to claim 24, wherein when the detection unit detects that that the finger touches the display unit, the control unit causes information on a first application assigned to a particular way of touching to the display unit by the finger to be displayed on the display unit.

26. The electronic device according to claim 24, wherein the control unit identifies a movement of the finger on the display unit and causes information on a second application assigned to the identified movement of the finger to be displayed on the display unit.
